(19) United States
(12) Patent Application Publication
(10) Pub. No.: US 2013/0018730 A1
(43) Pub. Date: Jan. 17, 2013

(54) METHOD AND APPARATUS FOR DISTRIBUTING PROMOTIONAL MATERIALS

(71) Applicants: Nadia Morris, Decatur, GA (US); Andrea Basso, Marlboro, NJ (US); Tara Hines, New York, NY (US); Aleksey Ivanov, Atlantic High, NJ (US); Jeffrey Mikan, Atlanta, GA (US)

(72) Inventors: Nadia Morris, Decatur, GA (US); Andrea Basso, Marlboro, NJ (US); Tara Hines, New York, NY (US); Aleksey Ivanov, Atlantic High, NJ (US); Jeffrey Mikan, Atlanta, GA (US)

(73) Assignee: AT&T Intellectual Property I, LP, Atlanta, GA (US)

(21) Appl. No.: 13/184,555

(22) Filed: Jul. 17, 2011

(51) Int. Cl. G06Q 30/00

(52) U.S. Cl. 705/14.61; 705/14.71; 705/14.69

(57) ABSTRACT

A system that incorporates teachings of the present disclosure may include, for example, computer instructions to identify a subscriber leader, identify a plurality of subscriber followers that track activities of the subscriber leader, detect from the activities of the subscriber leader a behavioral pattern that influences a consumption behavior of the subscriber followers, receive a request for media content from at least one of a plurality of devices of the subscriber followers, identify in the media content a substitutable product, select a promotional system to supply a promotional product according to at least one of a winning bid supplied by the promotion system and the behavioral pattern, substitute the substitutable product in the media content with the promotional product to generate updated media content, and transmit the updated media content to the at least one of the plurality of devices of the subscriber followers. Other embodiments are disclosed.

### RELATED APPLICATION(S)

U.S. patent application Ser. No. 13/167,998, filed Jun. 24, 2011, by Nadia et al., entitled “Method and Apparatus for Targeted Advertising.” U.S. patent application Ser. No. 13/173,839, filed Jun. 30, 2011, by Nadia et al., entitled “Method and Apparatus for Marketability Assessment.” All sections of the aforementioned applications are incorporated herein by reference.

### FIELD OF THE DISCLOSURE

The present disclosure relates to a method and apparatus for distributing promotional materials.

### BACKGROUND

Some merchants promote consumer products on broadcast television by way of advertisements interleaved with popular television programs. Merchants have also promoted their products by arranging agreements with celebrities to promote their products. In other instances, merchants promote products in a subtle manner by positioning products (e.g., soda cans) in a noticeable background setting of a television program.

### BRIEF DESCRIPTION OF THE DRAWINGS

FIGS. 1-2 depict illustrative embodiments of communication systems that provide media services;

FIG. 3 depicts an illustrative embodiment of a web portal for interacting with the communication systems of FIGS. 1-2;

FIG. 4 depicts an illustrative embodiment of a communication device utilized in the communication systems of FIGS. 1-2;

FIG. 5 depicts an illustrative embodiment of a system;

FIGS. 6-7 depict illustrative embodiments of methods operating in portions of the systems described in FIGS. 1-5; and

FIG. 8 is a diagrammatic representation of a machine in the form of a computer system within which a set of instructions, when executed, may cause the machine to perform any one or more of the methods described herein.

### DETAILED DESCRIPTION

The present disclosure describes, among other things, illustrative embodiments for targeted advertising by identifying subscribers (followers) who directly or indirectly are influenced by other subscribers (leaders). The present disclosure describes exemplary embodiments that can include determining a behavior of leaders and/or followers and known characteristics of each group to perform targeted advertising more effectively. The exemplary embodiments that can further include auctioning to promoters of products and/or services access to media content consumed or generated by the subscriber leaders and/or followers. The present disclosure also addresses resolution of conflicts between promoters requesting access to promote similar products or services for the same media content of a subscriber leader or follower.

One embodiment of the present disclosure includes a method for identifying a subscriber leader, identifying a plurality of subscriber followers who track activities of the subscriber leader, and detecting a behavioral pattern from at least one of media content consumed from at least one of a first plurality of devices of the subscriber leader and from media content transmitted by at least one of the first plurality of devices of the subscriber leader to a second plurality of devices of the plurality of subscriber followers. The method can further include detecting a request to transmit during one of a plurality of time slots first media content from at least one of the first plurality of devices of the subscriber leader to the second plurality of devices of the plurality of subscriber followers, identifying in the first media content a first plurality of substitutable advertisement products, and identifying at least one of a plurality of advertiser systems procuring access to the requested time slot. The method can also include substituting the first plurality of substitutable advertisement products in the first media content with a second plurality of advertisement products supplied by the at least one advertiser system according to the detected behavioral pattern to generate updated first media content, and transmitting the updated first media content to the second plurality of devices of the plurality of subscriber followers.

One embodiment of the present disclosure includes a device having a memory coupled to a controller. The controller can be operable to determine a behavioral pattern of at least one of a subscriber leader and a plurality of subscriber followers who track activities of the subscriber leader and detect a first request to transmit first media content from a first device of a first plurality of devices of the subscriber leader to a second plurality of devices of the plurality of subscriber followers. The controller can also be operable to identify in the first media content a first substitutable product, identify a first advertiser system offering a first bid to substitute the first substitutable product with a first advertisement product, identify a second advertiser system offering a second bid to substitute the first substitutable product with a second advertisement product, and accept the first bid over the second bid according to at least one of bidding criteria and the behavioral pattern. The controller can be further operable to substitute the first substitutable product in the first media content with the first advertisement product supplied by the first advertiser to generate updated first media content, and transmit the updated first media content to the second plurality of devices of the plurality of subscriber followers.

One embodiment of the present disclosure includes a computer-readable storage medium having computer instructions to identify a subscriber leader, identify a plurality of subscriber followers that track activities of the subscriber leader, and detect from the activities of the subscriber leader a behavioral pattern that influences a consumption behavior of the plurality of subscriber followers. The storage medium can further have computer instructions to receive a request for media content from at least one of a plurality of devices of the plurality of subscriber followers, identify in the media content a substitutable product, select a promotional system to supply a promotional product according to at least one of a winning bid supplied by the promotion system and the behavioral pattern, substitute the substitutable product in the media content with the promotional product supplied by the promotional system to generate updated media content, and transmit the updated media content to the at least one of the plurality of devices of the plurality of subscriber followers.

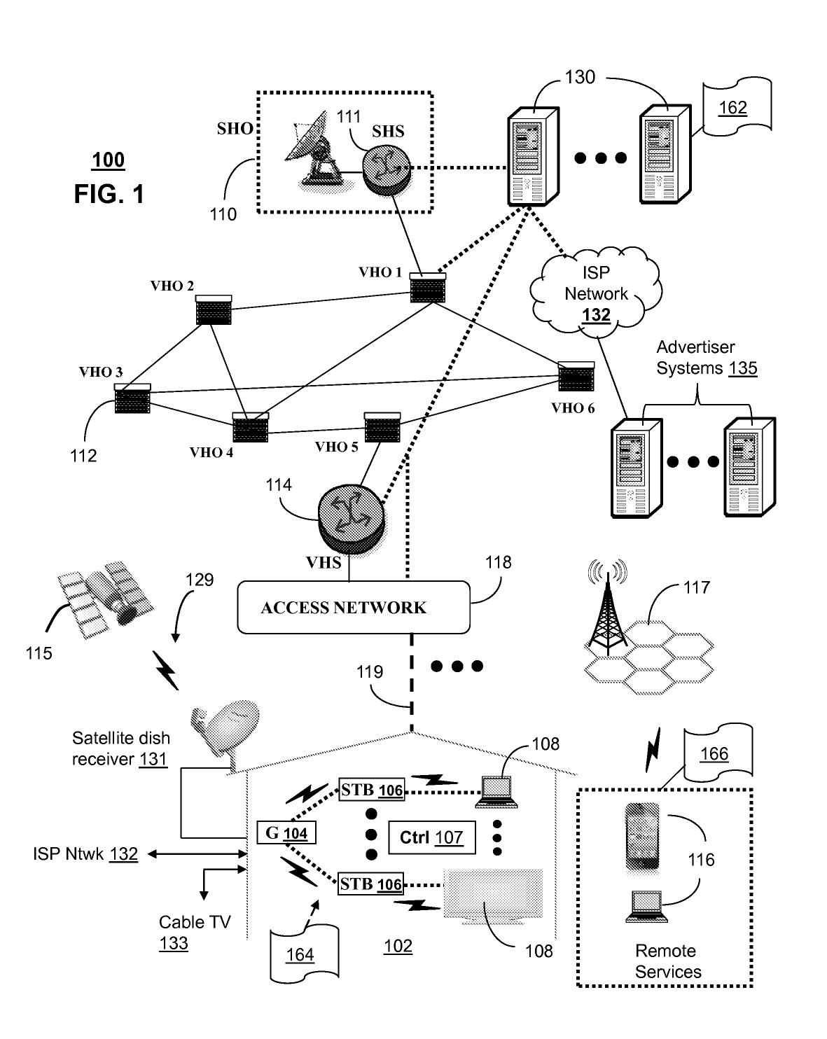

FIG. 1 depicts an illustrative embodiment of a communication system 100 for delivering media content. The communication system 100 can be adapted to deliver and exchange media content between subscribers. The communication system 100 can also be adapted to identify subscriber leaders and followers who directly or indirectly are influenced by the subscribers leaders. The communication system 100 can be further adapted to determine a behavior of subscriber leaders and/or followers to perform targeted advertising more effectively. The present disclosure further describes exemplary embodiments in which the communication system 100 can be operable to auction to promoters of products and/or services access to media content consumed or generated by the subscriber leaders and/or followers. The present disclosure also describes exemplary embodiments in which the communication system 100 can be adapted to resolve conflicts between promoters requesting access to promote similar products or services for the same media content of a subscriber leader or follower.

The communication system 100 can represent an Internet Protocol Television (IPTV) media system. The IPTV media system can include a super head-end office (SHO) 110 with at least one super headend office server (SHS) 111 which receives media content from satellite and/or terrestrial communication systems. In the present context, media content can represent, for example, audio content, moving image content such as 2D or 3D videos, video games, virtual reality content, still image content, and combinations thereof. The SHS server 111 can forward packets associated with the media content to one or more video head-end servers (VHS) 114 via a network of video head-end offices (VHO) 112 according to a common multicast communication protocol.

The VHS 114 can distribute multimedia broadcast content via an access network 118 to commercial and/or residential buildings 102 housing a gateway 104 (such as a residential or commercial gateway). The access network 118 can represent a group of digital subscriber line access multiplexers (DSLAMs) located in a central office or a service area interface that provide broadband services over fiber optical links or copper twisted pairs 119 to buildings 102. The gateway 104 can use common communication technology to distribute broadcast signals to media processors 106 such as Set-Top Boxes (STBs) which in turn present broadcast channels to media devices 108 such as computers or television sets managed in some instances by a media controller 107 (such as an infrared or RF remote controller).

The gateway 104, the media processors 106, and media devices 108 can utilize tethered communication technologies (such as coaxial, powerline or phone line wiring) or can operate over a wireless access protocol such as Wireless Fidelity (WiFi), Bluetooth, Zigbee, or other present or next generation local or personal area wireless network technologies. By way of these interfaces, unicast communications can also be invoked between the media processors 106 and subsystems of the IPTV media system for services such as video-on-demand (VoD), browsing an electronic programming guide (EPG), or other infrastructure services.

A satellite broadcast television system 129 can be used also in the media system of FIG. 1. The satellite broadcast television system can be overlaid, operably coupled with, or replace the IPTV system as another representative embodiment of communication system 100. In this embodiment, signals transmitted by a satellite 115 carrying media content can be received by a satellite dish receiver 131 coupled to the building 102. Modulated signals received by the satellite dish receiver 131 can be transferred to the media processors 106 for demodulating, decoding, encoding, and/or distributing broadcast channels to the media devices 108. The media processors 106 can be equipped with a broadband port to the ISP network 132 to enable interactive services such as VoD and EPG as described above.

In yet another embodiment, an analog or digital cable broadcast distribution system such as cable TV system 133 can be overlaid, operably coupled with, or replace the IPTV system and/or the satellite TV system as another representative embodiment of communication system 100. In this embodiment, the cable TV system 133 can also provide Internet, telephony, and interactive media services.

It is contemplated that the present disclosure can apply to other present or next generation over-the-air and/or landline media content services system.

Some of the network elements of the IPTV media system can be coupled to one or more computing devices 130, a portion of which can operate as a web server for providing web portal services over an Internet Service Provider (ISP) network 132 to wireline media devices 108 or wireless communication devices 116.

Communication system 100 can also provide for all or a portion of the computing devices 130 to function as a server that performs targeted advertising directed to subscriber leaders and subscriber followers (herein referred to as server 130). The server 130 can use common computing and communication technology to perform function 162, which can include among things, identifying subscriber leaders and subscriber followers, observing the behavior of either or both groups, assessing a commercial value of each group, auctioning to promoters access to media content requested or exchanged between subscriber leaders and followers, resolving conflicts between promoters requesting access to the same or a similar targeted product or service promoted by way of the media content, and/or modifying media content with targeted advertisements selected according to a bidding process and/or the observed behavior of subscriber leaders and followers.

The server 130 can also be operable to receive promotional materials from the advertisement systems 135 of FIG. 1. The advertisement systems 135 can utilize server technology similar to servers 130, and can be communicatively coupled to server 130 by way of the ISP network 132. Each of the advertiser servers 135 can be operated and supervised by unaffiliated promoters. The promotional materials supplied by the advertiser server 135 can be used as a substitute for products identified in the media content created or consumed by the subscriber leaders and/or followers.

Server 130 can perform other functions as will be described below. The media processors 106 and wireless communication devices 116 can be adapted with software functions 164 and 166, respectively, to utilize the services of server 130.

Multiple forms of media services can be offered to media devices over landline technologies such as those described above. Additionally, media services can be offered to media devices by way of a wireless access base station 117 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless network technologies are contemplated by the present disclosure.

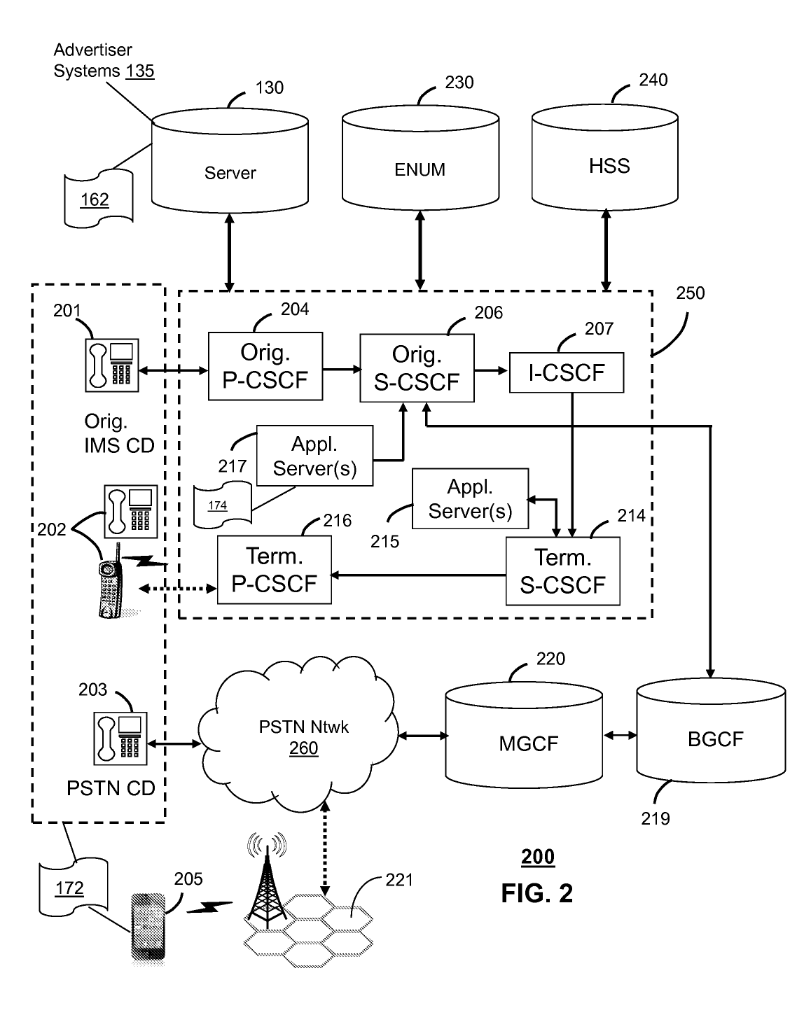

FIG. 2 depicts an illustrative embodiment of a communication system 200 employing an IP Multimedia Subsystem (IMS) network architecture to facilitate the combined services of circuit-switched and packet-switched systems. Communication system 200 can be overlaid or operably coupled with communication system 100 as another representative embodiment of communication system 100.

Communication system 200 can comprise a Home Subscriber Server (HSS) 240, a tElephone NUmber Mapping (ENUM) server 230, and other common network elements of an IMS network 250. The IMS network 250 can establish communications between IMS-compliant communication devices (CDs) 201, 202, Public Switched Telephone Network (PSTN) CDs 203, 205, and combinations thereof by way of a Media Gateway Control Function (MGCF) 220 coupled to a PSTN network 260. The MGCF 220 need not be used when a communication session involves IMS CD to IMS CD communications. A communication session involving at least one PSTN CD may utilize the MGCF 220.

IMS CDs 201, 202 can register with the IMS network 250 by contacting a Proxy Call Session Control Function (P-CSCF) which communicates with an interrogating CSCF (I-CSCF), which in turn, communicates with a Serving CSCF (S-CSCF) to register the CDs with the HSS 240. To initiate a communication session between CDs, an originating IMS CD 201 can submit a Session Initiation Protocol (SIP INVITE) message to an originating P-CSCF 204 which communicates with a corresponding originating S-CSCF 206. The originating S-CSCF 206 can submit the SIP INVITE message to one or more application servers (ASs) 217 that can provide a variety of services to IMS subscribers.

For example, the application servers 217 can be used to perform originating call feature treatment functions on the calling party number received by the originating S-CSCF 206 in the SIP INVITE message. Originating treatment functions can include determining whether the calling party number has international calling services, call ID blocking, calling name blocking, 7-digit dialing, and/or is requesting special telephony features (e.g., *72 forward calls, *73 cancel call forwarding, *67 for caller ID blocking, and so on). Based on initial filter criteria (iFCs) in a subscriber profile associated with a CD, one or more application servers may be invoked to provide various call originating feature services.

Additionally, the originating S-CSCF 206 can submit queries to the ENUM system 230 to translate an E.164 telephone number in the SIP INVITE message to a SIP Uniform Resource Identifier (URI) if the terminating communication device is IMS-compliant. The SIP URI can be used by an Interrogating CSCF (I-CSCF) 207 to submit a query to the HSS 240 to identify a terminating S-CSCF 214 associated with a terminating IMS CD such as reference 202. Once identified, the I-CSCF 207 can submit the SIP INVITE message to the terminating S-CSCF 214. The terminating S-CSCF 214 can then identify a terminating P-CSCF 216 associated with the terminating CD 202. The P-CSCF 216 may then signal the CD 202 to establish Voice over Internet Protocol (VoIP) communication services, thereby enabling the calling and called parties to engage in voice and/or data communications. Based on the iFCs in the subscriber profile, one or more application servers may be invoked to provide various call terminating feature services, such as call forwarding, do not disturb, music tones, simultaneous ringing, sequential ringing, etc.

In some instances the aforementioned communication process is symmetrical. Accordingly, the terms “originating” and “terminating” in FIG. 2 may be interchangeable. It is further noted that communication system 200 can be adapted to support video conferencing. In addition, communication system 200 can be adapted to provide the IMS CDs 201, 202 with the multimedia and Internet services of communication system 100 of FIG. 1.

If the terminating communication device is instead a PSTN CD such as CD 203 or CD 205 (in instances where the cellular phone only supports circuit-switched voice communications), the ENUM system 230 can respond with an unsuccessful address resolution which can cause the originating S-CSCF 206 to forward the call to the MGCF 220 via a Breakout Gateway Control Function (BGCF) 219. The MGCF 220 can then initiate the call to the terminating PSTN CD over the PSTN network 260 to enable the calling and called parties to engage in voice and/or data communications.

It is further appreciated that the CDs of FIG. 2 can operate as wireline or wireless devices. For example, the CDs of FIG. 2 can be communicatively coupled to a cellular base station 221, a femtocell, a WiFi router, a DECT base unit, or another suitable wireless access unit to establish communications with the IMS network 250 of FIG. 2. The cellular access base station 221 can operate according to common wireless access protocols such as Global System for Mobile (GSM), Code Division Multiple Access (CDMA), Time Division Multiple Access (TDMA), Universal Mobile Telecommunications (UMTS), World interoperability for Microwave (WiMAX), Software Defined Radio (SDR), Long Term Evolution (LTE), and so on. Other present and next generation wireless network technologies are contemplated by the present disclosure. Accordingly, multiple wireline and wireless communication technologies are contemplated for the CDs of FIG. 2.

It is further contemplated that cellular phones supporting LTE can support packet-switched voice and packet-switched data communications and thus may operate as IMS-compliant mobile devices. In this embodiment, the cellular base station 221 may communicate directly with the IMS network 250.

The server 130 of FIG. 1 can be operably coupled to the second communication system 200 and the advertiser systems 135 for purposes similar to those described above. It is further contemplated by the present disclosure that server 130 can perform function 162 and thereby provide targeted advertising services to the CDs 201, 202, 203 and 205 of FIG. 2. CDs 201, 202, 203 and 205, which can be adapted with software to perform function 172 to utilize the services of the server 130. It is further contemplated that the server 130 can be an integral part of the application server(s) 217 performing function 174, which can be substantially similar to function 162 and adapted to the operations of the IMS network 250.

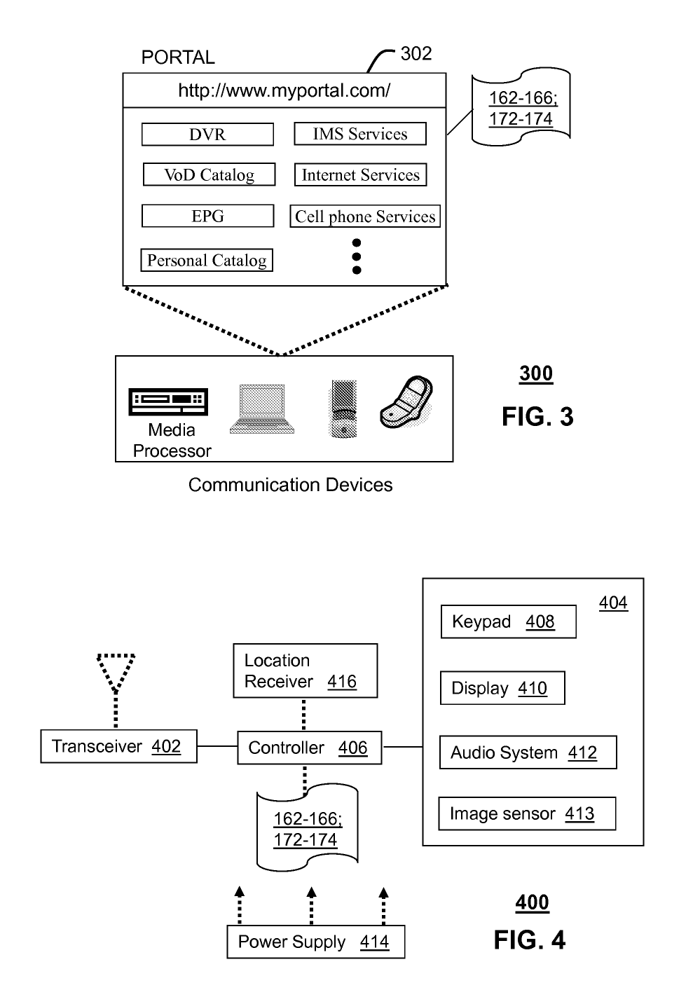

FIG. 3 depicts an illustrative embodiment of a web portal 302 which can be hosted by server applications operating from the computing devices 130 of the communication system 100 illustrated in FIG. 1. The web portal 302 can be used for managing services of communication systems 100-200. A web page of the web portal 302 can be accessed by a Uniform Resource Locator (URL) with an Internet browser such as Microsoft's Internet Explorer™, Mozilla's Firefox™, Apple's Safari™, or Google's Chrome™ using an Internet-capable communication device such as those described in FIGS. 1-2. The web portal 302 can be configured, for example, to access a media processor 106 and services managed thereby such as a Digital Video Recorder (DVR), a Video on Demand (VoD) catalog, an Electronic Programming Guide (EPG), or a personal catalog (such as personal videos, pictures, audio recordings, etc.) stored at the media processor 106. The web portal 302 can also be used for provisioning IMS services described earlier, provisioning Internet services, provisioning cellular phone services, and so on.

It is contemplated by the present disclosure that the web portal 302 can further be utilized to manage and provision software applications 162-166 and 172-174 to adapt these applications as may be desired by subscribers and service providers of communication systems 100-200.

FIG. 4 depicts an exemplary embodiment of a communication device 400. Communication device 400 can serve in whole or in part as an illustrative embodiment of the devices depicted in FIGS. 1-2. The communication device 400 can comprise a wireline and/or wireless transceiver 402 (herein transceiver 402), a user interface (UI) 404, a power supply 414, a location receiver 416, and a controller 406 for managing operations thereof. The transceiver 402 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 402 can also be adapted to support circuit-switched wireline access technologies (such as PSTN), packet-switched wireline access technologies (such as TCPIP, VoIP, etc.), and combinations thereof.

The UI 404 can include a depressible or touch-sensitive keypad 408 with a navigation mechanism such as a roller ball, a joystick, a mouse, or a navigation disk for manipulating operations of the communication device 400. The keypad 408 can be an integral part of a housing assembly of the communication device 400 or an independent device operably coupled thereto by a tethered wireline interface (such as a USB cable) or a wireless interface supporting for example Bluetooth. The keypad 408 can represent a numeric keypad commonly used by phones, and/or a QWERTY keypad with alphanumeric keys. The UI 404 can further include a display 410 such as monochrome or color LCD (Liquid Crystal Display), OLED (Organic Light Emitting Diode) or other suitable display technology for conveying images to an end user of the communication device 400. In an embodiment where the display 410 is touch-sensitive, a portion or all of the keypad 408 can be presented by way of the display 410 with navigation features.

The UI 404 can also include an audio system 412 that utilizes common audio technology for conveying low volume audio (such as audio heard only in the proximity of a human ear) and high volume audio (such as speakerphone for hands free operation). The audio system 412 can further include a microphone for receiving audible signals of an end user. The audio system 412 can also be used for voice recognition applications. The UI 404 can further include an image sensor 413 such as a charged coupled device (CCD) camera for capturing still or moving images.

The power supply 414 can utilize common power management technologies such as replaceable and rechargeable batteries, supply regulation technologies, and charging system technologies for supplying energy to the components of the communication device 400 to facilitate long-range or short-range portable applications. The location receiver 416 can utilize common location technology such as a global positioning system (GPS) receiver capable of assisted GPS for identifying a location of the communication device 400 based on signals generated by a constellation of GPS satellites, thereby facilitating common location services such as navigation.

The communication device 400 can use the transceiver 402 to also determine a proximity to a cellular, WiFi, Bluetooth, or other wireless access points by common sensing techniques such as utilizing a received signal strength indicator (RSSI) and/or a signal time of arrival (TOA) or time of flight (TOF). The controller 406 can utilize computing technologies such as a microprocessor, a digital signal processor (DSP), and/or a video processor with associated storage memory such as Flash, ROM, RAM, SRAM, DRAM or other storage technologies.

The communication device 400 can be adapted to perform the functions of the media processor 106, the media devices 108, or the portable communication devices 116 of FIG. 1, as well as the IMS CDs 201-202 and PSTN CDs 203-205 of FIG. 2. It will be appreciated that the communication device 400 can also represent other common devices that can operate in communication systems 100-200 of FIGS. 1-2 such as a gaming console and a media player.

It is contemplated by the present disclosure that the communication device 400 shown in FIG. 4 or portions thereof can serve as a representation of one or more of the devices of communication systems 100-200. It is further contemplated that the controller 406 can be adapted in various embodiments to perform the functions 162-166 and 172-174, respectively.

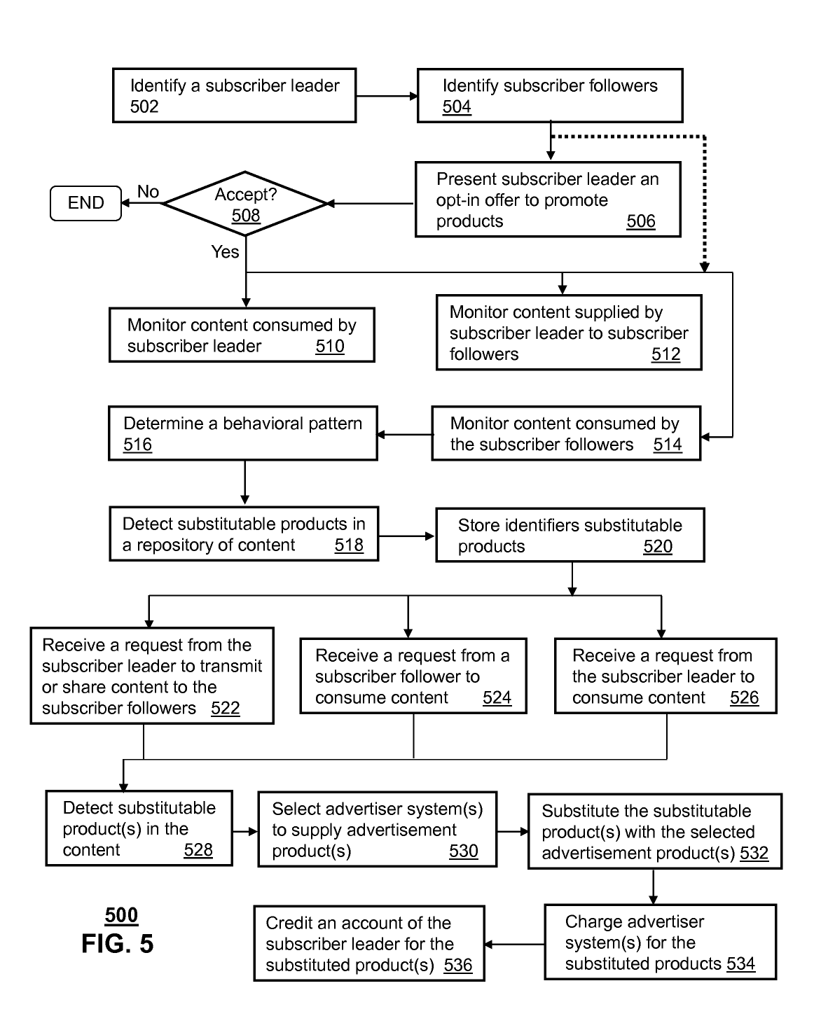

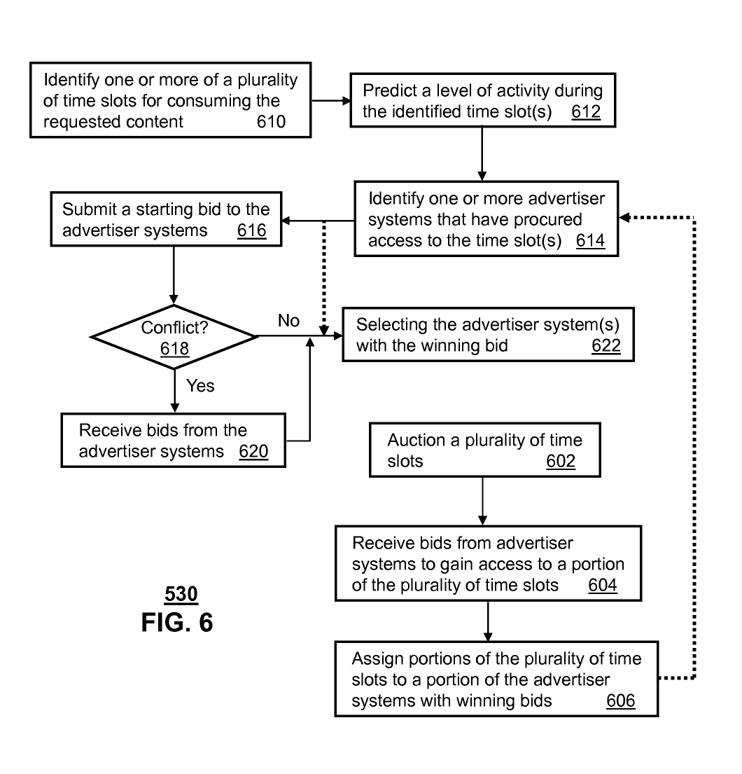

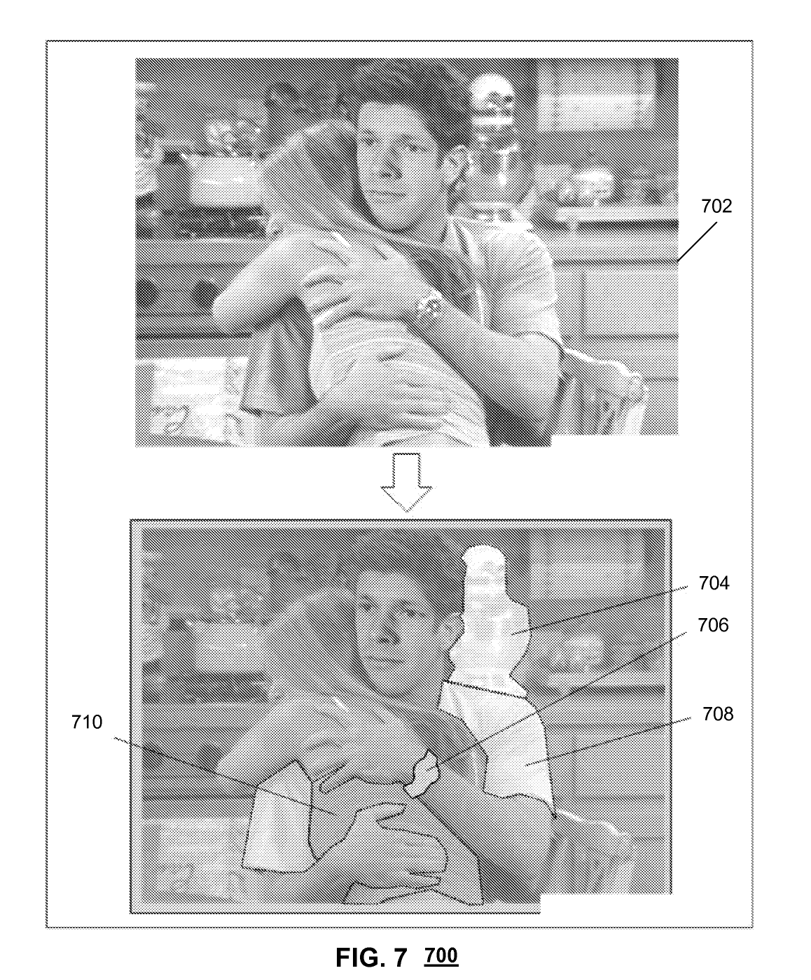

FIGS. 5-6 depict illustrative methods 500-600 that operate in portions of the devices of FIGS. 1-5. Method 500 can begin with step 502 in which the server 130 identifies in steps 502 and 504 a subscriber leader and corresponding subscriber followers. In the present context a subscriber leader can represent a subscriber of the communication systems of FIGS. 1-3 which can draw an interest from other subscribers (referred to herein as subscriber followers) to track the activities of the subscriber leader. In one embodiment, subscriber followers can choose to expressly identify themselves as followers and subscribe to a service to proactively follow the activities of the subscriber leader much like subscribers of social network services such as Twitter®. In another embodiment, subscriber followers can on their own accord follow the activities of a subscriber leader by way of interactive communications (landline calls, cellular calls, email, SMS or MMS messaging), browsing on the Internet for news about the subscriber leader, acquiring access to the subscriber leader's personal media content (e.g., personal videos, pictures, music), monitoring the behavior of a subscriber leader's blog web page, or joining as members of the subscriber leader's social network page (e.g., FaceBook®). Other suitable techniques in which subscriber followers can directly or indirectly track the activities of the subscriber leader are contemplated by the present disclosure.

Server 130 can be adapted to identify a subscriber leader by direct membership subscription initiated by subscriber followers to track the activities of the subscriber leader (such as is the case for members of Twitter®, FaceBook®, and so on). In cases where a subscription process is not available, the server 130 can also be adapted to monitor network traffic to identify frequent communications between subscriber leaders and followers (email, SMS or MMS, landline or mobile calls), one-way proactive monitoring of the subscriber leader by subscriber followers (e.g., Internet browsing, blog browsing, etc.), or one-way communications directed from subscriber leaders to subscriber followers (e.g., forwarding or publishing media content that is directed to subscriber followers).

In one embodiment subscriber leaders and subscriber followers can be subscribers of the same service provider of communication and media services. In another embodiment subscriber leaders and subscriber followers can be subscribed to services from different service providers. In this instance, the service providers can share or provide access to network traffic of each other's subscribers to enhance detection of subscriber leaders and followers, or such information can be indirectly determined from cross-over traffic between the networks of the service providers.

In step 506, the subscriber leader can be presented an opt-in offer from the service provider to promote products or services of advertisers. The opt-in offer can offer the subscriber leader discounted or free media services or monitory rewards for products promoted by way of monitored activities of the subscriber leader. The opt-in offer can present to the subscriber leader terms and conditions for the discounted services and/or monetary rewards, as well as it may describe the extent and manner to which the subscriber leader and/or followers will be monitored by the server 130 to conduct targeted advertising directed to the subscriber leader and the subscriber followers. If the subscriber leader rejects the offer, then targeted advertising is not performed by the server 130. If, on the other hand, the subscriber leader accepts the offer, then the server 130 can begin to monitor activities of these parties.

For example, in step 510, the server 130 can monitor media content consumed by the subscriber leader. This step can represent a subscriber leader that consumes audio content (music, radio), video (VoD), email, SMS or MMS messages from subscriber followers or third party sources, Internet browsing of content, and so on. In step 512, the server 130 can monitor media content supplied by the subscriber leader to the subscriber followers. This step can represent, for example, a subscriber leader that shares content with subscriber followers by direct transfers or access to a web page of a social network (similar to FaceBook®). The shared content can be audio content, video content, pictures, etc. This step can also represent communications with subscriber followers such as voice communications, SMS or MMS messages, email, text messaging via a web page of a social network (e.g., Twitter®, FaceBook®).

The server 130 can also monitor, in step 514, content consumed by the subscriber followers. The content consumed by the subscriber followers can be content generated by the subscriber leader or content requested by the subscriber followers from a source other than the subscriber leader. In this embodiment, content is broadly contemplated. For instance, content can include audio content, video content, still image content, text and/or audio messages, and so on.

Based on the activities monitored in steps 510-512, the server 130 can be adapted in step 516 to determine a behavioral pattern. The behavioral pattern can represent a detected behavioral pattern of the subscriber leader, a behavioral pattern of the subscriber followers, or combinations thereof. To determine the influence of the subscriber leader on the subscriber followers, the server 130 can be adapted to perform correlation analysis between the content consumed by the subscriber leader (step 510), the content generated by the subscriber leader (step 512), and the content consumed by the subscriber followers (step 514). For instance, the server 130 can determine a high correlation between the subscriber leader and subscriber followers in the case of content consumed by the subscriber followers that was generated by the subscriber leader. The server 130 can also determine the volume of content generated by the subscriber leader, the frequency that the subscriber leader generates content, and the degree that the subscriber followers consume this content.

In the case of content consumed by subscriber followers that is not generated by the subscribe leader, the server 130 can be adapted to determine whether the content consumed by the subscriber followers is correlated with the content generated by the subscriber leader. A high correlation would indicate that the subscriber leader has a high degree of influence on the subscriber followers. Such a correlation can be determined from similarities in the content generated by the subscriber leader and the content consumed by the subscriber followers. For example, the subscriber leader may post a blog in which the subscriber leader encourages its readers to follow Star Trek episodes. The subscriber leader can also suggest dates to view episodes to engage in discussions about the episode. The server 130 can detect the posted messages in the blog and correlate actions taken by the subscriber followers that indicate the subscriber followers are following the suggestions of the subscriber leader.

In addition to the above embodiments for describing a behavioral pattern of the subscriber leader and the subscriber followers, the server 130 can assess a demographic profile of the subscriber leader and the subscriber followers from service accounts of each subscriber (e.g., age, gender, services subscribed, family size, income, credit, etc.). The server 130 can, for example, assess that the subscriber followers are within a particular age group and income bracket. The server 130 can also determine from the consumption behavior of the subscriber leader and subscriber followers a psychographic profile of the subscribers. The psychographic profile can identify biases (likes and dislikes) and traits of the subscribers, which can be indicative of a potential spending behavior relative to classes of products or services. The behavioral pattern can also indicate how the subscriber leader influences the consumption behavior of the subscriber followers.

The behavioral patterns described above can be determined by the server 130 using present and future statistical techniques as they are made available. Once behavioral patterns have been assessed, the server 130 can begin to perform targeted advertising with the subscriber leader and/or subscriber followers. In preparation for targeted advertising, the server 130 can be adapted to preprocess media content that it distributes. The server 130 can for example identify elements of a media program that may be marketable and which can be substituted with other marketable products depending on the biases determined from the behavioral patterns detected in step 516.

For example, suppose the server 130 finds an episode of a TV program such as shown in FIG. 6. The server 130 can analyze frames in the episode such as frame 702, and identify with image processing techniques items such as a blender 704, a watch 706, male apparel 708, and female apparel 710. Using image processing technology the contours of these items can be identified in step 518, and associated with identifiers that can be recorded in step 520 to enable the server 130 promptly determine candidate products which can be substituted with products of advertisers in subsequent scheduled releases of the program or upon request (VoD) by subscriber leaders or followers. The default setting of such media content is to maintain the identified items as originally authored by the producers of the media program. In addition to substituting items in a media program, the server 130 can be adapted to insert advertisements in scheduled advertisements slots that are tailored to the subscriber leader and subscriber followers based on the detected behavior(s) of step 516.

The server 130 can be adapted to receive a request from the subscriber leader to transmit and/or share content with the subscriber followers. If the content being transmitted or shared represent content stored in the repository described in step 518, then the server 130 can retrieve the identifiers stored in step 520 to promptly identify potential substitutable products in the content. If, on the other hand, the content being transmitted or shared is random content generated by the subscriber leader, then the server 130 can perform the image processing analysis described above to identify substitutable products, and can generate identifiers that the server 130 can store for future identification of these substitutable products.

In step 528, the server 130 can be adapted to detect the substitutable products in the content to be transmitted or shared by retrieving the identifiers described above. The server 130 can then determine a product type for each substitutable product detected. For example, the server 130 can detect a substitutable product that is a soda can, a kitchen appliance, and so on. Based on the bias factors determined from the detected behavioral patterns of the subscriber leader and subscriber followers, the server 130 can select in step 530 one or more advertiser systems 130 to supply advertisement products from a pool of advertisement products that match the detected product types. In step 532, the server 130 can be adapted to substitute the detected substitutable products with the selected advertisement products using image processing technology. If the content being distributed by the subscriber leader is video content and the substitutable product is not stationary, then the server 130 can use image processing technology to adapt the advertisement products to the movements of the substitutable products so that it appears as if the products were part of the originally authored content.

The foregoing process can be adapted to process content such as a request from a subscriber follower in step 524 or a request from the subscriber leader in step 526 to consume content. The requested content from either party can be processed so that identifiable substitutable products are replaced with advertisement products that match a product type of the substitutable products and that match the interests of the parties as determined from their respective behavioral patterns. As noted earlier, intermediate advertisements presented between scheduled advertisements can also be substituted with targeted advertisements that conform to the detected biases determined from the behavioral patterns.

When content has been updated with targeted advertisements as described above for either the subscriber leader or subscriber followers, the server 130 can proceed to step 534 where it can be adapted to charge advertisers who supplied the advertised products with a fee. The fee charged can be based on a prearranged agreement between the service provider of server 130 and advertisers. The fee can be charged each time updated content is distributed, or when a certain volume of updated content distributions is reached. As an incentive to the subscriber leader for opting into targeted advertising, the server 130 can be adapted to credit an account of the subscriber leader each time updated content distributions take place or when they occur in bulk. The credit given can represent a monetary reward or discount in media services supplied by the service provider(s) of communication systems 100-200. Such rewards can be an incentive for subscriber leaders to make an effort to draw as large a subscriber follower base as possible so that the rewards are significant.

Referring to FIG. 6, method 600 describes a selection process for advertiser systems 135 mentioned in step 530 of FIG. 5. Method 600 can begin with step 602 where the server 130 auctions to the advertiser systems 135 access to a plurality of time slots used by the subscriber leader and/or followers to exchange and/or consume media content. The time slots can be uniform (e.g., ½ hour slots) or non-uniform in duration depending on the detected behavioral pattern of the subscriber leader and/or subscriber followers. For example, there may be peak times when the subscriber leader is communicating with subscriber followers and at which time the subscriber followers are known to consume more media content than usual. There may be other times when the communication and/or consumption activities of the subscriber leader and/or followers are less significant. The server 130 can be adapted to monitor the aforementioned activities of the subscriber leader and followers and identify duration delimiters for each of the time slots to mimic identifiable behaviors of the subscriber leader and followers.

The server 130 can be operable to assess a commercial value for providing the advertiser systems 135 access to one or more time slots to perform targeted advertising. The commercial value can be determined according to a size of the subscriber follower base and/or how active the subscriber followers are in consuming media content. Other marketing criteria can be used to assess a commercial value of each time slot such as, for example, the likelihood that the subscriber followers will purchase or subscribe to an advertised product or service based on a history of purchases or subscriptions by the subscriber followers monitored by the server 130. There can be other methods for assessing a commercial value, which are contemplated by the present disclosure.

The auctioning process started at step 602 can consist of a starting bid offered by the server 130 to the advertiser servers 135 based on the commercial value assessed for each time slot. The server 130 can receive in step 604 bids from the advertiser systems 135 that are the same or higher than the starting bid offered by the server 130. Each bid can represent fees that the server 130 can charge when products or services promoted by way of the advertiser system 135 are substituted in media content as described in steps 532-534 of FIG. 5. The server 130 can assign in step 606 portions of the plurality of time slots to a portion of the advertiser systems 135 with winning bids. There may be instances where the server assigns the same time slot to multiple advertiser systems 135 providing an equal winning bid. Assigning more than one advertiser system 135 to the same time slot can provide the server 130 an expansive set of advertisement products from which to choose, thereby enhancing the ability of the server 130 to more readily perform targeted advertising with subscriber leaders and followers based on detected behavioral patterns. Steps 602-606 can represent steps applied at a set up time prior to initiating method 500 of FIG. 5, and steps 610-622 of FIG. 6. Once steps 602-606 have been completed, the assigned time slots can be used in step 614 as will be described shortly.

When step 530 of FIG. 5 is invoked, the server 130 can proceed to step 610 of FIG. 6 where the server 130 identifies one or more time slots according to a scheduled consumption time of the media content established by the requesting party (subscriber leader or follower) or established by the service provider offering the media content. The time slots identified by the server 130 can also be based on the duration for consuming the requested content. The server 130 can predict in step 612 a level of activity during the identified time slots based on historical data and prior identified behavioral patterns. At step 614, the server 130 can identify one or more advertiser systems 135 that have procured access to the identified time slots. At step 616, the server 130 can submit a starting bid to the advertiser systems 135 identified in step 614. This step can be the result of the server 130 determining that there is more than one time slot and more than one advertiser system 135 that has procured access to the same time slots. Step 616 can also result from the server 130 determining that that level of activities of the subscriber leader and/or followers predicted in step 612 has increased beyond the assessed commercial value used in steps 602-606, thereby warranting a need to reinitiate the bidding process with the advertiser systems 135 that previously procured these time slots. The increased activities of the subscriber followers can be a result of the population of subscriber followers increasing, and/or the influence of the subscriber leader on the subscriber followers changing the behavioral pattern of the subscriber followers.

If in step 528 of FIG. 5 the server 130 detected that there's only one substitutable product in the requested content, then the server 130 can proceed to step 618 to resolve a conflict between two or more advertiser systems 135 requesting access to the same time slot(s) and the same substitutable product. The server 130 can resolve the conflict according to bids received in step 620 from the conflicted advertiser systems 135. Based on the received bids, the server 130 can select a single advertiser system 135 in step 622 based on a winning bid. If, on the other hand, there are no conflicts in accessing the substitutable product, and/or there's only one advertiser system 135 that has procured access to the time slot(s), then the server 130 can proceed to step 622 where it selects the advertiser system 135 providing the only winning bid (e.g., a bid that equates to the starting bid of step 616). It is further noted that if activities of the subscriber leader and/or followers is consistent with the commercial value assigned to the time slots in steps 602-604, and there are no conflicts between advertiser systems 135 vying for the same substitutable product, then the bidding process identified in steps 616-620 can be skipped, and the server 130 can proceed to step 622 where it selects the advertiser system(s) 135 on the basis of the procured time slots without a winning bid.

Upon reviewing the aforementioned embodiments, it would be evident to an artisan with ordinary skill in the art that said embodiments can be modified, reduced, or enhanced without departing from the scope of the claims described below. For example, there can be instances where an opt-in offer is not a necessary condition to enable the services of the server 130. For example, subscribers of communication systems 100-200 may already have accepted in their service contract that the service provider can monitor their activities. In this embodiment, method 500 can be adapted to skip steps 506-508. In another embodiment, if state or federal laws allow a service provider to monitor its subscribers without consent, then steps 506 and 508 can also be avoided. Method 500 can also be adapted for substitution of audio segments, still image segments, or any other substitutable form of identifiable media content. Method 500 can also be adapted to charge advertisers fees that are based on a marketable value determined for the subscriber leader. The marketable value of the subscriber leader can be determined, for example, based on the population size of subscriber followers, their respective growth rate, and the demographic profile of such subscribers.

Other embodiments are contemplated by the present disclosure.

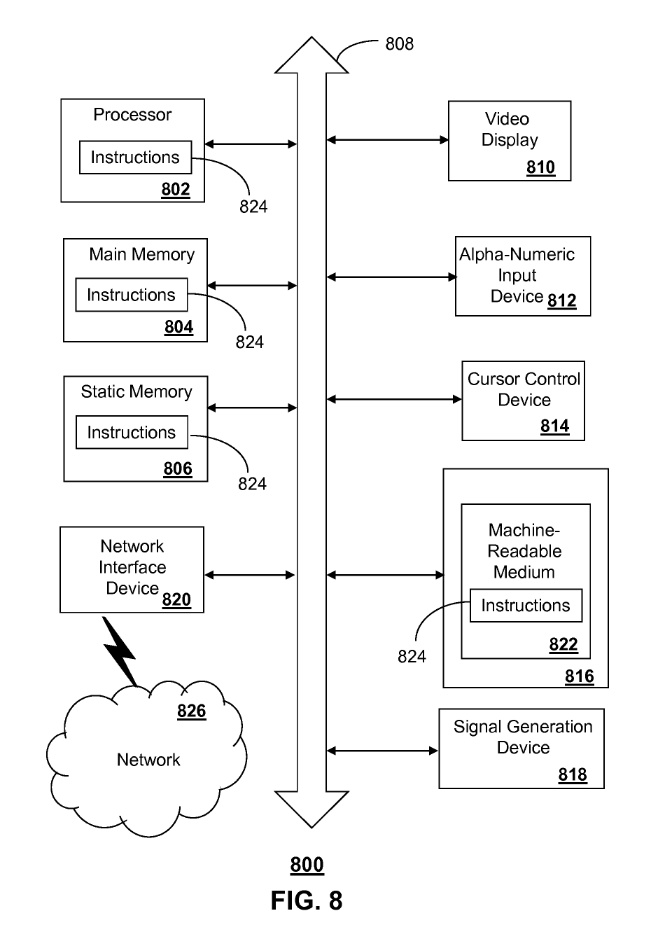

FIG. 8 depicts an exemplary diagrammatic representation of a machine in the form of a computer system 800 within which a set of instructions, when executed, may cause the machine to perform any one or more of the methods discussed above. One or more instances of the machine can operate, for example, as the server 130, media processor 106, portable devices 108, and other devices of FIGS. 1-2. It is further contemplated that server 130 can represent a combination of computing devices distributed throughout the communication systems of FIGS. 1-3. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 800 may include a processor 802 (e.g., a central processing unit (CPU), a graphics processing unit (GPU, or both), a main memory 804 and a static memory 806, which communicate with each other via a bus 808. The computer system 800 may further include a video display unit 810 (e.g., a liquid crystal display (LCD), a flat panel, or a solid state display. The computer system 800 may include an input device 812 (e.g., a keyboard), a cursor control device 814 (e.g., a mouse), a disk drive unit 816, a signal generation device 818 (e.g., a speaker or remote control) and a network interface device 820.

The disk drive unit 816 may include a tangible computer-readable storage medium 822 on which is stored one or more sets of instructions (e.g., software 824) embodying any one or more of the methods or functions described herein, including those methods illustrated above. The instructions 824 may also reside, completely or at least partially, within the main memory 804, the static memory 806, and/or within the processor 802 during execution thereof by the computer system 800. The main memory 804 and the processor 802 also may constitute tangible computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

While the tangible computer-readable storage medium 622 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the present disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth, WiFi, Zigbee), and long-range communications (e.g., WiMAX, GSM, CDMA, LTE) are contemplated for use by computer system 800.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, are contemplated by the present disclosure.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
identifying a subscriber leader;
identifying a plurality of subscriber followers who track activities of the subscriber leader;
detecting a behavioral pattern from at least one of media content consumed from at least one of a first plurality of devices of the subscriber leader and from media content transmitted by at least one of the first plurality of devices of the subscriber leader to a second plurality of devices of the plurality of subscriber followers;
detecting a request to transmit during one of a plurality of time slots first media content from at least one of the first plurality of devices of the subscriber leader to the second plurality of devices of the plurality of subscriber followers;
identifying in the first media content a first plurality of substitutable advertisement products;
identifying at least one of a plurality of advertiser systems procuring access to the requested time slot;
substituting the first plurality of substitutable advertisement products in the first media content with a second plurality of advertisement products supplied by the at least one advertiser system according to the detected behavioral pattern to generate updated first media content; and
transmitting the updated first media content to the second plurality of devices of the plurality of subscriber followers.

2. The method of claim 1, comprising detecting a conflict between two advertiser systems from the plurality of advertiser systems requesting access to the time slot for promoting one of the identified first plurality of substitutable advertisement products.

3. The method of claim 2, comprising auctioning to the two advertiser systems access to the identified substitutable advertisement product.

4. The method of claim 3, comprising:
receiving a winning bid from one of the two advertiser systems; and
substituting one of the first plurality of substitutable advertisement products with an advertisement product supplied by the advertiser system providing the winning bid.

5. The method of claim 3, comprising transmitting a starting bid to the two advertiser systems.

6. The method of claim 5, comprising:
predicting a level of activity by the plurality of subscriber followers during the requested time slot; and
determining the starting bid according to the predicted level of activity of the plurality of followers.

7. The method of claim 6, comprising determining the predicted level of activity by the plurality of followers during the requested time slot according to at least one of an event occurring near a time of the requested time slot and a history of media consumption activity by the plurality of followers during the requested time slot.

8. The method of claim 1, comprising:
auctioning to the plurality of advertiser systems at least one of a plurality of time slots used by the subscriber leader to transmit media content from one of the first plurality of devices of the subscriber leader to the second plurality of devices of the plurality of subscriber followers;
receiving from each of the plurality of advertiser systems a bid to procure access to at least one of the plurality of time slots;
selecting at least a portion of the plurality of advertiser systems according to a winning bid provided by the selected portion of advertiser systems; and
assigning at least one of the plurality of times slots to the selected portion of advertiser systems.

9. The method of claim 1, comprising:
transmitting to one of the first plurality of devices of the subscriber leader an opt-in offer to monitor the media content consumed by at least one of the first plurality of devices of the subscriber leader and the media content transmitted by at least one of the first plurality of devices of the subscriber leader to the second plurality of devices of the plurality of subscriber followers;
receiving an acceptance of the opt-in offer from one of the first plurality of devices of the subscriber leader; and
monitoring the media content consumed by at least one of the first plurality of devices of the subscriber leader and the media content transmitted by at least one of the first plurality of devices of the subscriber leader to the second plurality of devices of the plurality of subscriber followers responsive to receiving the acceptance of the opt-in offer.

10. The method of claim 1, comprising:
identifying a product type of each of the first plurality of substitutable advertisement products; and
selecting the at least one advertiser system according to the product type and the detected behavioral pattern.

11. The method of claim 1, comprising transmitting a charge to the at least one advertiser system representative of a fee for each of the second plurality of advertisement products promoted in the updated first media content.

12. The method of claim 11, comprising determining the charge according to a marketable score assigned to the subscriber leader.

13. The method of 12, comprising determining the marketable score from at least one of a total number of the plurality of subscriber followers, a growth rate of subscriber followers tracking activities of the subscriber leader, a value of media content consumed by the subscriber leader, and a value of media content consumed by the subscriber followers.

14. The method of claim 1, wherein the behavioral pattern corresponds to a detected bias for at least one product type.

15. The method of claim 1, comprising crediting an account of the subscriber leader for transmitting the updated first media content.

16. A device comprising a memory coupled to a controller, wherein the controller is operable to:
determine a behavioral pattern of at least one of a subscriber leader and a plurality of subscriber followers who track activities of the subscriber leader;
detect a first request to transmit first media content from a first device of a first plurality of devices of the subscriber leader to a second plurality of devices of the plurality of subscriber followers;
identify in the first media content a first substitutable product;
identify a first advertiser system offering a first bid to substitute the first substitutable product with a first advertisement product;
identify a second advertiser system offering a second bid to substitute the first substitutable product with a second advertisement product;
accept the first bid over the second bid according to at least one of bidding criteria and the behavioral pattern;
substitute the first substitutable product in the first media content with the first advertisement product supplied by the first advertiser to generate updated first media content; and
transmit the updated first media content to the second plurality of devices of the plurality of subscriber followers.

17. The device of claim 16, wherein the request identifies a first time slot of a plurality of time slots to transmit the first media content, and wherein the controller is operable to select the first and second advertiser systems from a plurality of advertiser systems based on the first and second advertiser systems having procured access to the first time slot.

18. The device of claim 17, wherein the controller is operable to:
predict a level of activity by the plurality of subscriber followers during the first time slot;
determine a starting bid according to the predicted level of activity of the plurality of followers; and
transmit a starting bid to the first and second advertiser systems

19. A computer-readable storage medium, comprising computer instructions to:
identify a subscriber leader;
identify a plurality of subscriber followers that track activities of the subscriber leader;
detect from the activities of the subscriber leader a behavioral pattern that influences a consumption behavior of the plurality of subscriber followers;
receive a request for media content from at least one of a plurality of devices of the plurality of subscriber followers;
identify in the media content a substitutable product;
select a promotional system to supply a promotional product according to at least one of a winning bid supplied by the promotion system and the behavioral pattern;
substitute the substitutable product in the media content with the promotional product supplied by the promotional system to generate updated media content; and
transmit the updated media content to the at least one of the plurality of devices of the plurality of subscriber followers.

20. The storage medium of claim 19, comprising computer instructions to:
receive an opt-in acceptance from a device of the subscriber leader to monitor activities of the subscriber leader; and
receive authorization from a system of a producer of the media content to substitute identifiable products in media content with advertisement products.
